(19) United States
(12) Patent Application Publication
(10) Pub. No.: US 2001/0028416 A1
(43) Pub. Date: Oct. 11, 2001

(54) System and method for displaying 3D imagery using a dual projector 3D stereoscopic projection system

(76) Inventors: Adam W. Divelbiss, Wappingers Falls, NY (US); David C. Swift, Cortlandt Manor, NY (US)

Correspondence Address: Gerow D. Brill, Esq., Reveo, Inc., 85 Executive Boulevard, Elmsford, NY, 10523, US

(21) Appl. No.: 09/772,128

(22) Filed: Jan. 29, 2001

Related U.S. Application Data
(60) Provisional application No. 60/179,909, filed on Feb. 3, 2000.

(51) Int. Cl. G02F 1/136

(52) U.S. Cl. 349/43

(57) ABSTRACT

An exemplary embodiment is a system and method for displaying three-dimensional imagery. The system includes an image source, a first projector having light emission, a second projector having a light emission and a twisted nematic liquid crystal rotator disposed in the light emission of the first projector. The first projector and second projector are connected to the image source.

### CROSS REFERENCE TO RELATED APPLICATIONS

This application claims the benefit of U.S. provisional patent application No. 60/179,909 filed Feb. 3, 2000, the entire contents of which are incorporated herein by reference.

### BACKGROUND

The invention relates generally to a system and method for displaying three-dimensional imagery with a dual projector three-dimensional stereoscopic projection system, and more specifically, to a dual projector three-dimensional stereoscopic projection system using a twisted nematic liquid crystal rotator or a ½ wave retarder.

Stereoscopic projection systems enable multiple people to view three-dimensional (3D) images at the same time. Typically stereoscopic projection systems employ either one or two single projection units in the display of 3D stereoscopic images. There are advantages and disadvantages with both single and dual projection unit methods of stereoscopic projection. The invention described herein addresses problems associated with dual unit stereoscopic projection systems. A major problem associated with dual unit systems involves the 3D “cross talk” or “ghosting” effect seen in projected images. This problem typically stems from the method used to encode the left and right perspective images required for stereoscopic imaging.

There are several types of dual projection systems that use either internal or external methods to alter the polarization of light exiting one or both of the two projectors to produce a projected image with stereoscopic depth information. An internal method is one in which modifications are made inside the projection unit to alter the polarization characteristics of its light output. Likewise an external method is on in which modifications are made outside the projection unit. In either case, a dual unit stereoscopic projection system displays a 3D image by encoding the left perspective image with polarization state P1 and the right perspective image with an orthogonal polarization state P2. Both left and right perspective images are displayed in the same location on a view screen that preserves polarized light. The observer perceives depth from such images by wearing polarized glasses that decode the stereoscopic image on the screen. The left lens of the glasses consists of a polarizing filter that passes P1 polarized light. Similarly, the right lens of the glasses consists of a polarizing filter that passes P2 polarized light. Using this configuration the left eye should see only the left perspective image and the right eye should see only the right perspective image.

In order to realize a dual unit stereoscopic projection system, typically one or both projection units must be modified in such a way that the light output is polarized and that the two polarization states are orthogonal. In addition, the polarization states must match those of the polarizing filters used in the decoder glasses. The most common method employs linearly polarized 3D glasses in a “V” configuration where the left lens consists of a linear polarizing filter with polarization axis oriented −45° from vertical. Similarly the right lens of the decoder glasses consists of a second linear polarizing filter with polarization axis oriented +45° from vertical (or vice versa).

For a large panel amorphous silicon (a-Si) thin film transistor liquid crystal display (TFT LCD) projector the light output is already polarized with a 45° angle. Typically, one projector is left unmodified and the second projector light output is modified in one of two ways. The first method involves placing a ½-wave retarder (optical phase shift material) in the output path of one of the projectors. The ½-wave retarder is oriented in such a way that the polarization angle of the output light is rotated by 90°. The retarder material may be located either internal or external to the projector casing. The second method involves modifying the LCD panel inside of one projector so that the polarization angle of the output is orthogonal to the unmodified projector. The modification consists of physically reorienting the polarizer and analyzer of the LCD by 90°.

For projectors in which the light output is not polarized, such as CRT (cathode ray tube) based projectors and DLP (digital light process) projectors, both projectors must be modified. In these cases linear polarizers are placed in the output path of both projectors such that the polarization angles of the two projectors are orthogonal and correspond to the decoding glasses.

Dual projector three-dimensional (3D) stereoscopic projection systems that utilize a ½-wave retarder to modify the output polarization angle have an inherent “ghosting” or image cross talk problem due to the spectral characteristics of the ½-wave retarder material itself. Many retarder materials have “blue leakage” in which light in the blue wavelengths is not completely rotated by 90°. The result is that one eye will see a faint blue ghost image from the opposite perspective image. Note that different retarder materials may exhibit “leakage” at other wavelengths. If it becomes too prominent, this ghosting effect can degrade or destroy the stereoscopic effect. Further, dual projector 3D stereoscopic projection systems that utilize two cathode ray tube (CRT) or two digital light processor (DLP) projectors (or any other projector with non-polarized light output) suffer a reduction in brightness of at least 50% due to the linear polarizer placed in the light path of each projector.

Thus there is a great need for an improved method and system for generating stereoscopic images of 3D objects, while avoiding the shortcomings of prior art apparatus and methodologies.

### SUMMARY OF THE INVENTION

An exemplary embodiment is a system and method for displaying three-dimensional imagery. The system includes an image source, a first projector having light emission, a second projector having a light emission and a twisted nematic liquid crystal rotator disposed in the light emission of the first projector. The first projector and second projector are connected to the image source.

### BRIEF DESCRIPTION OF THE DRAWINGS

Referring now to the drawings wherein like elements are numbered alike in several FIGURES:

FIG. 1 illustrates a prior art dual projector 3D stereoscopic system using two amorphous silicon thin film transistor liquid crystal display projectors and a ½-wave retarder;

FIG. 2 illustrates another prior art dual projector 3D stereoscopic system using two amorphous silicon thin film transistor liquid crystal display projectors;

FIG. 3 illustrates a prior art dual projector 3D stereoscopic system that utilizes two projectors with non-polarized light output and with the left and right perspective images altered by placing linearly polarizing filters in each projector's output light path;

FIG. 4 illustrates the spectral characteristics of a typical sample of ½-wave retarder;

FIG. 5 illustrates a percent transmittance plot for a TN rotator sandwiched between two linearly polarizing filters aligned in parallel;

FIG. 6 illustrates a functional diagram of a TN rotator;

FIG. 7 illustrates a representation of the cross-section of a typical TN rotator;

FIG. 8 illustrates a dual projector 3D stereoscopic system using two amorphous silicon thin film transistor liquid crystal display projectors and an external TN rotator;

FIG. 9 illustrates a dual projector 3D stereoscopic system using two amorphous silicon thin film transistor liquid crystal display projectors, an external TN rotator and two external polarizers;

FIG. 10 illustrates a dual projector 3D stereoscopic system using dual polysilicon projectors and two ½-wave retarders;

FIG. 11 illustrates a signal input diagram depicting green channel interchanging used for stereoscopic image encoding in the dual projector 3D stereoscopic systems of FIGS. 10 and 12;

FIG. 12 illustrates a dual projector 3D stereoscopic system using dual polysilicon projectors and two external TN rotators; and

FIG. 13 illustrates another dual projector 3D stereoscopic system using dual polysilicon projectors and two external TN rotators.

### DETAILED DESCRIPTION

As discussed, dual projector three-dimensional (3D) stereoscopic projection systems that utilize a ½-wave retarder to modify the output polarization angle have an inherent “ghosting” or image cross talk problem due to the spectral characteristics of the ½-wave retarder material itself. Further, as previously mentioned, dual projector 3D stereoscopic projection systems that utilize two cathode ray tube (CRT) or two digital light processor (DLP) projectors (or any other projector with non-polarized light output) suffer a reduction in brightness of at least 50% due to the linear polarizer placed in the light path of each projector.

However, using a twisted nematic liquid crystal rotator (TN rotator) plate with LCD based projectors, instead of ½-wave optical retarder material, greatly reduces the amount of cross talk and ghosting due to its superior spectral characteristics. The TN rotator configuration is also superior to using dual CRT or DLP projectors with external polarizers since the transmission loss in the TN rotator is very small compared to the losses in linear polarizer sheets. In addition, the TN rotator can be used with 3-chip polysilicon (p-Si) projection systems in which the polarization of the red and blue light channels is orthogonal to the polarization of the green channel.

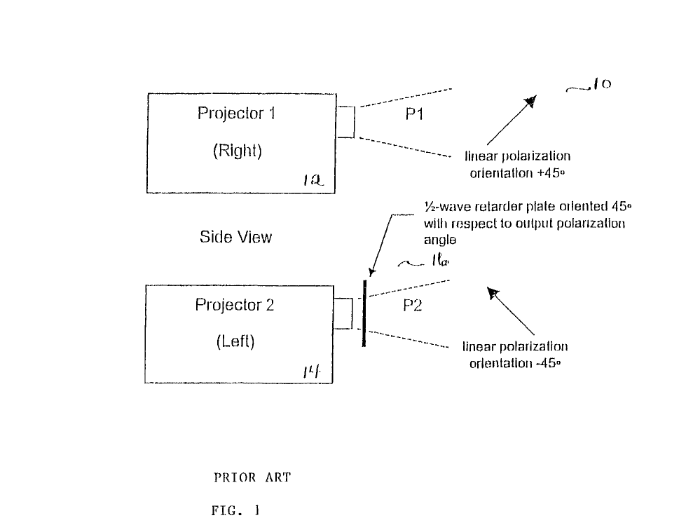

In general, the embodiments described herein use a TN rotator or a ½ wave retarder to optically alter the images for a variety of dual projector applications. Note that the embodiments may also include any projector having one color channel polarized orthogonal to the other two color channels, and are not limited to the specific projectors described herein. However, for ease of illustration, the embodiments shown in the figures illustrate the TN rotator(s), ½ wave retarders and touch up polarizers external to the projectors. However, other embodiments may include the TN rotator(s), ½ wave retarders and touch up polarizers (and a combination thereof) positioned within the projectors or even a combination of internal and external positions. FIG. 1 illustrates a prior art dual projector 3D stereoscopic system 10 using two amorphous silicon (a-Si) thin film transistor liquid crystal display (TFT LCD) projectors 12 and 14 and a ½-wave retarder 16. A characteristic of this type of projector is that the exiting light is polarized at a 45° angle from the vertical due to the LCD's output analyzer (linearly polarizing filter). The “reference” polarization state of the first projector 12 is labeled P1. A ½-wave retarder plate 16 is typically positioned either externally (as shown in FIG. 1) or internally to produce an orthogonal polarization state, P2, for the second projector 14. The disadvantage of this prior art method lies in the fact that the ½-wave polarizing material is wavelength dependent and allows 3D cross talk in either the blue or red colors of the spectrum.

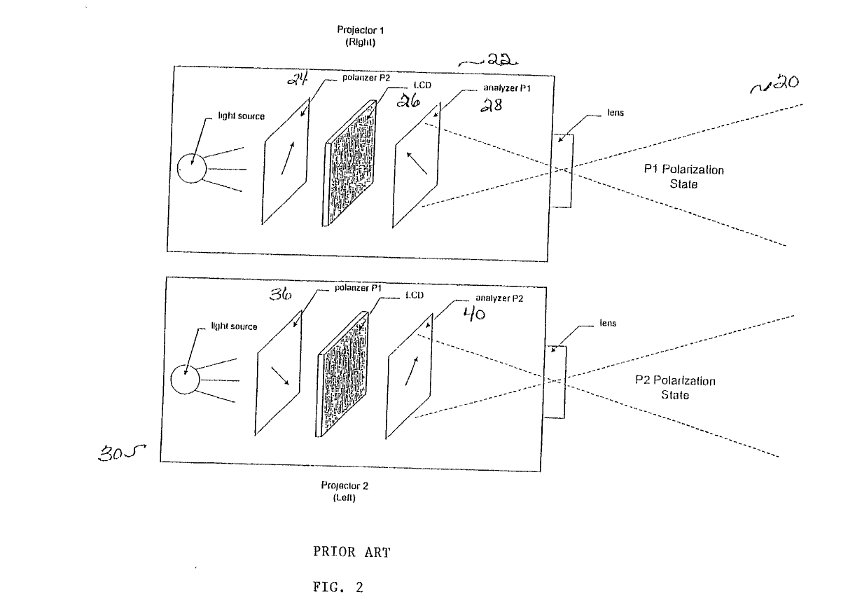

FIG. 2 illustrates another prior art dual projector 3D stereoscopic system 20 using two a-Si TFT LCD projectors. In FIG. 2, however, the LCD panel 26 of the first projector 22 is modified to output linearly polarized light with a polarization axis orthogonal to the normal, unmodified projector. The LCD polarizer 24 of the first projector 22 has state P2 and the LCD analyzer 28 has state P1. However, in the second projector 30, the LCD polarizer 36 has state P1 and the LCD analyzer 40 has state P2. The result is that the light output of the first projector 22 has a linear polarization axis of +45° and the light output of the second projector 30 has a polarization axis of −45°. A disadvantage of this prior art method is that the LCD display works best when the LCD polarizer and analyzer are unchanged. The modified LCD display will exhibit 3D cross talk and must be corrected with “touch-up” polarizers that reduce the light output of the projectors.

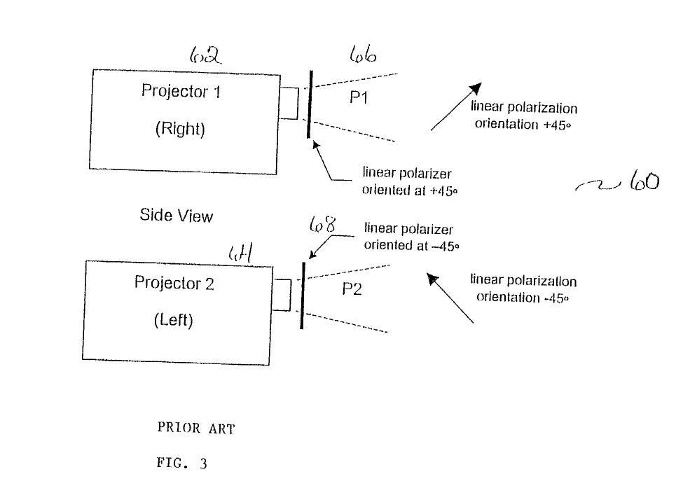

FIG. 3 illustrates a prior art dual projector 3D stereoscopic system 60 using two projectors 62 and 64 having non-polarized light output. In this system, the left and right perspective images are altered (or encoded) by placing linearly polarizing filters 66 and 68 in each projector's output light path. As FIG. 3 shows, the first projector 62 has a linear polarizer positioned such that the polarization axis is +45° with respect to the vertical, and the second projector 64 has a linear polarizer positioned such that the polarization axis is 45° with respect to the vertical. As previously discussed, over half the light output of each projector is absorbed in the polarizing filters 66 and 68, thus, reducing brightness by at least 50 percent.

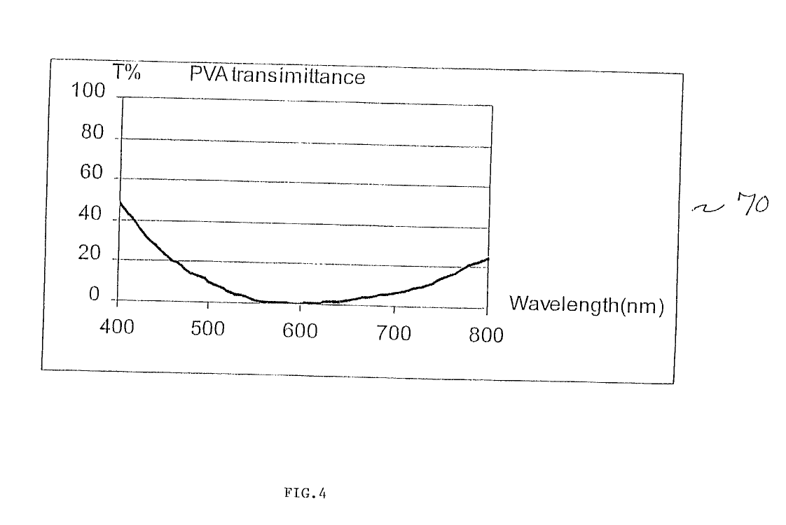

FIG. 4 illustrates the spectral characteristics 70 of a typical sample of ½-wave retarder, such as is produced by 3M Corporation. The graph shows the extinction of the ½-wave retarder. Extinction is defined as the percent transmittance of ½-wave retarder sandwiched between two linearly polarizing filters, whose polarization axes are aligned in parallel, and the optical axis of the ½-wave retarder is oriented at +/−45° from the polarization axis of the polarizing filters. The vertical axis represents the percent transmittance and the horizontal axis represents the light wavelength in units of nanometers. The horizontal axis spans the visible spectrum with blue on the left (around 500 mn) green in the middle (around 600 nm) and red on the right around (700 nm). Ultraviolet is on the far left and infrared is on the far right. FIG. 4 demonstrates the extinction between the P1 and P2 polarization states used to encode 3D images. As shown, that ½-wave retarder has good extinction in the “green” region of the spectrum but has much worse extinction in the blue and red regions. In other words, if this ½-wave retarder were used in a dual projector 3D stereoscopic system, persons viewing 3D images would most likely see blue or purple ghosting of the images. Note that a high level of percent transmittance results in heavy 3D cross talk or light “leakage” between each eye, resulting in possible ghosting of the image. Therefore, the best 3D quality results when the percent transmittance is as low as possible.

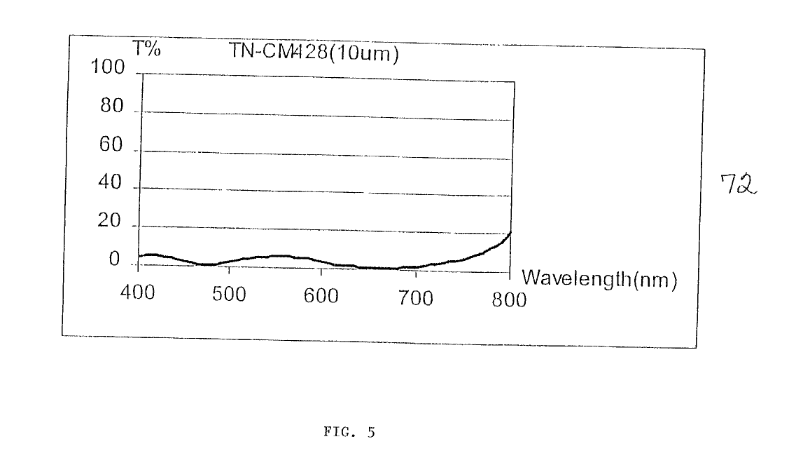

FIG. 5 illustrates a percent transmittance plot 72 for a TN rotator sandwiched between two linearly polarizing filters aligned in parallel. In this example, the TN rotator is made with liquid crystal (such as is manufactured by BASF) using 1 mm optically flat glass for the substrate. Note that a TN rotator is typically comprised of a sandwich of liquid crystal material between two glass plates. In the example of FIG. 5, the spacing between the glass plates is 10 micrometers. The overall percent transmittance has a much more uniformly flat spectrum than does the ½-wave retarder material. Thus, dual projector 3D stereoscopic projections systems using a TN rotator have better results than systems using a ½-wave retarder.

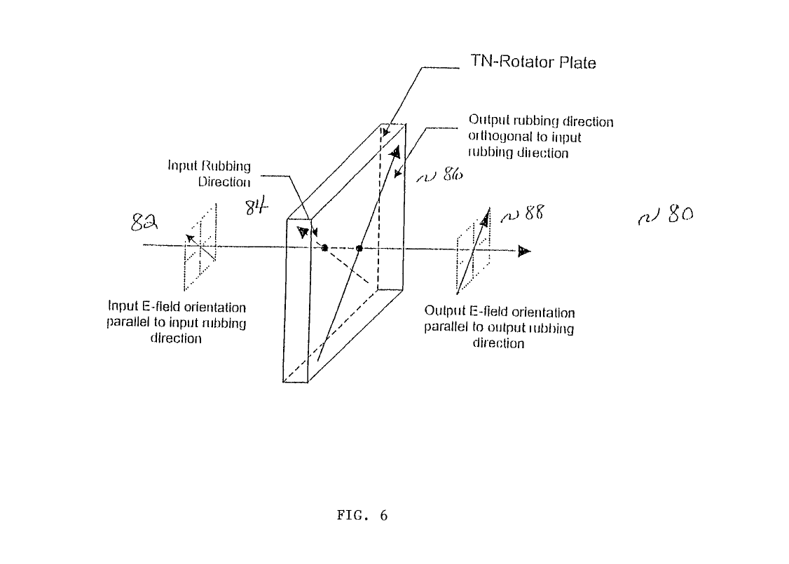

FIG. 6 illustrates a functional diagram 80 of a TN rotator 86. The TN rotator is constructed to rotate the input light's 82 electric field vector orientation a total of 90°. As shown, light entering the TN rotator 86 has an E-field orientation 84 of +45° with respect to the vertical. As light passes through the TN rotator, the E-field vector is rotated so that its orientation becomes 45° with respect to the vertical at the output 88. Note that TN rotators may be constructed such that the E-field vector may be rotated at any angle. In fact, for dual projector 3D stereoscopic projection systems in which certain p-Si or DILA (digital image light amplifier) projectors are used, a 0° to 45° TN rotator may be preferable. Such an embodiment is discussed below.

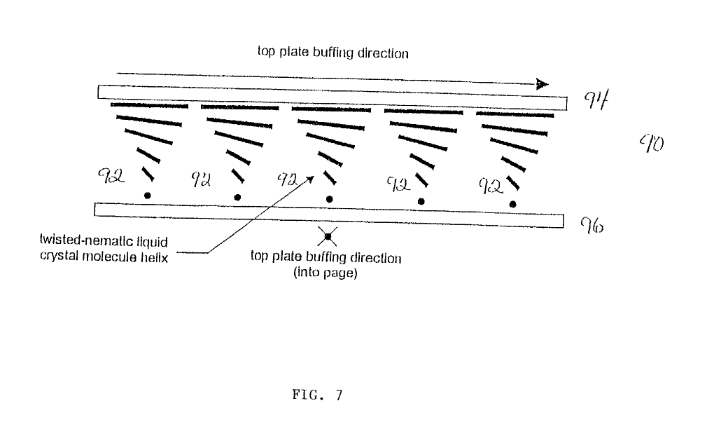

FIG. 7 illustrates a representation of the cross-section of a typical TN rotator 90. No matter what method is used to actually make a TN rotator, the basic result is to achieve a TN rotator with a cell in which the liquid crystal molecules are arranged in a helical chain. In the example of FIG. 7, several chains of liquid crystal molecules 92 having a helical structure (in which ¼ of a turn is realized in the helix) are shown. Starting from the top of the cell 94, liquid crystal molecules are represented as being oriented parallel to the page. Moving down, the molecules gradually rotate in orientation until they are pointing into the page at the bottom of the cell 96. Such a helical structure acts as a microscopic wave-guide for the light and causes the rotation of the light's E-field vector. In one embodiment, liquid crystal molecules may be aligned at the surface of the glass substrate using methods well known in the art of making liquid crystal cells and displays. These methods typically involve the application of a polyamide coating to the glass substrate. After the polyamide is applied, it is mechanically rubbed with felt or other soft material in the direction in which the liquid crystal molecules should be aligned. Thus, for a 0° to 90° TN rotator application, the polyamide is rubbed at 0° relative to the desired input E-field vector on the input glass substrate. For the output glass substrate, the polyamide is rubbed 90° with respect to the first rubbing direction.

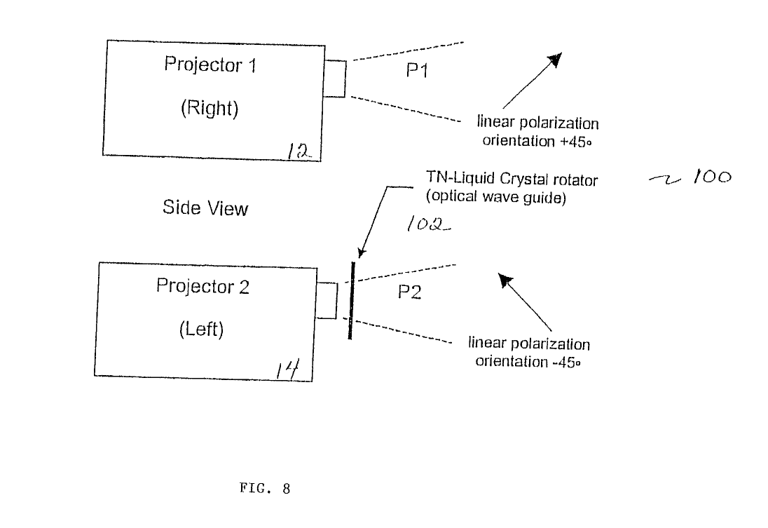

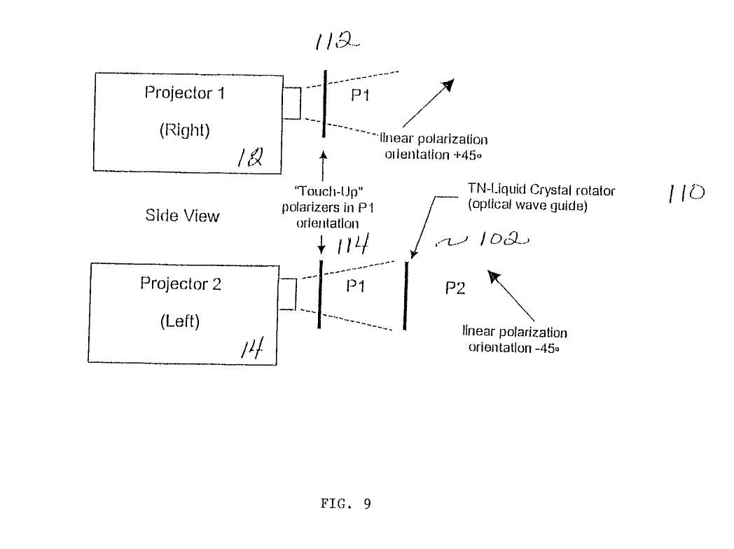

In the embodiment of FIG. 8, a dual projector 3D stereoscopic system 100 uses two a-Si TFT LCD projectors 12 and 14, and an external TN rotator 102 to obtain the P2 polarization state for the second projector 14. In the embodiment of FIG. 9, a dual projector 3D stereoscopic system 110 uses two a-Si TFT LCD projectors 12 and 14, an external TN rotator 102 and two external “touch-up” polarizers 112 and 114. Polarizers 112 and 114 are used to “clean up” the final light output. Note that some of the light output from a projector may not be polarized in the same direction, therefore, polarizers 112 and 114 may be used to remove the “stray” polarized light. In other words, polarizers 112 and 114 may be used to filter light that may be polarized in undesired directions. Also, note that for one embodiment, polarizers 112 and 114 are applied directly to the outputs of the two projectors 12 and 14. Polarizers 112 and 114 are aligned such that the axis of polarization is parallel to that of the projector itself. Thus, the polarizers further decrease the cross talk for projectors that do not have optimum native polarization characteristics for 3D images.

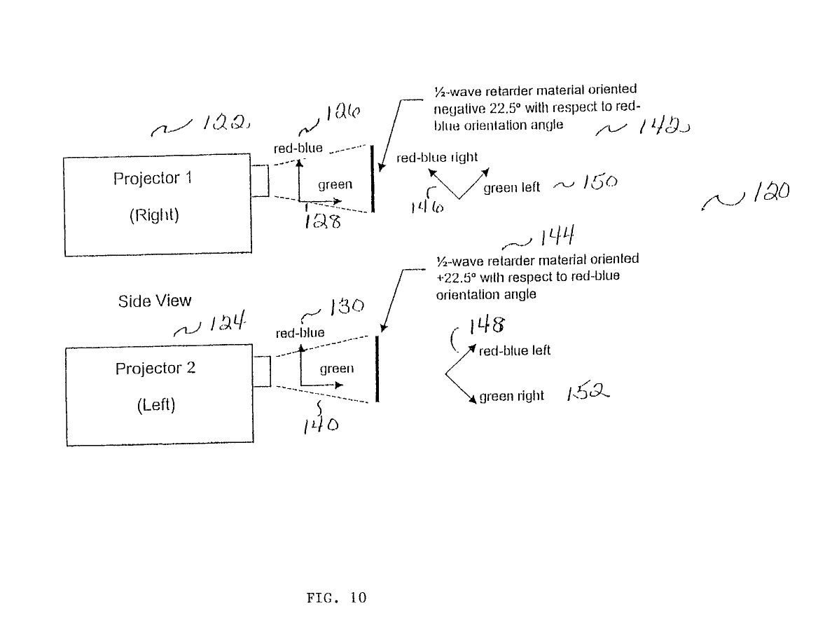

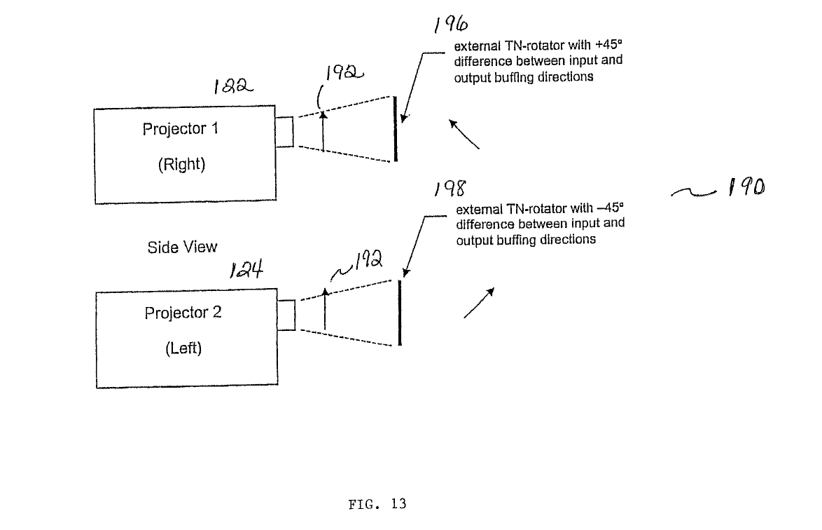

FIG. 10 illustrates a dual projector 3D stereoscopic system 120 using dual p-Si projectors 122 and 124 and two ½-wave retarders 142 and 144. The system 120 employs three separate p-Si LCD displays: one display for each color: red, green, or blue. Since each p-Si LCD display necessarily requires its own light path, the three separate light paths are recombined into a single, full-color, light source prior to the entering projection lens. A three-input, one output optical combiner cube may be used to recombine these light paths. Currently, there are two types of combiner cubes. The first type of combiner cube causes all of the light exiting the combiner cube (and therefore the projector) to have the same polarization state. However, the second type of combiner cube (as may be used in the system 120 of FIG. 10) causes the red and blue light 126 to have one linear polarization state 146 and the green light 128 to have an orthogonal polarization state 150. Note that an embodiment for a dual projector 3D stereoscopic system 190 using the first type of combiner cube is shown in FIG. 13 and discussed below. In the system of FIG. 10, ½-wave retarders 142 and 144 are applied to the output of the projectors 122 and 124 to alter or “encode” the light. The first projector 122 vertically polarizes the red and blue light 126, and horizontally polarizes the green light 128. Similarly, the second projector 124 vertically polarizes the red and blue light 130, and horizontally polarizes the green light 140. The first ½-wave retarder 142 is rotated −22.5° in order to rotate the polarization angle of both the red-blue light 146 and the green light 150 by a total of 45°. Similarly the second ½-wave retarder 144 is rotated +22.5° to achieve a rotation angle of +45° for both the red-blue 148 and green light 152. Thus, the polarization axis of the red-blue light 146 (from the first projector 122) is aligned with the polarization axis of the green light 152 (from the second projector 124). Similarly, the polarization axis of the green light 150 (from the first projector 122) is aligned with the polarization axis of the red-blue light 148 (from the second projector 124). In other words, a 3D stereoscopic image can be viewed if the first projector 122 is configured to display the red-blue light of the right perspective image, the green light of the left perspective image, and the second projector 124 is configured to display the red-blue light of the left perspective image and the green channel of the right perspective image.

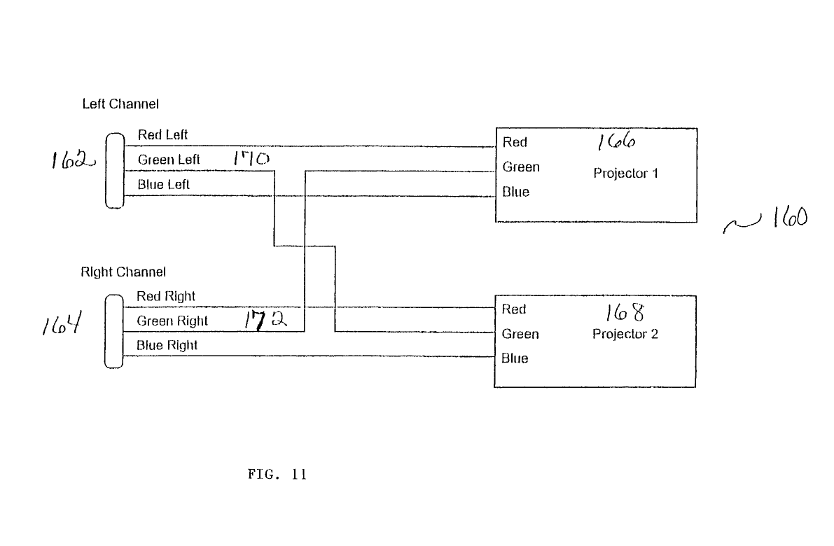

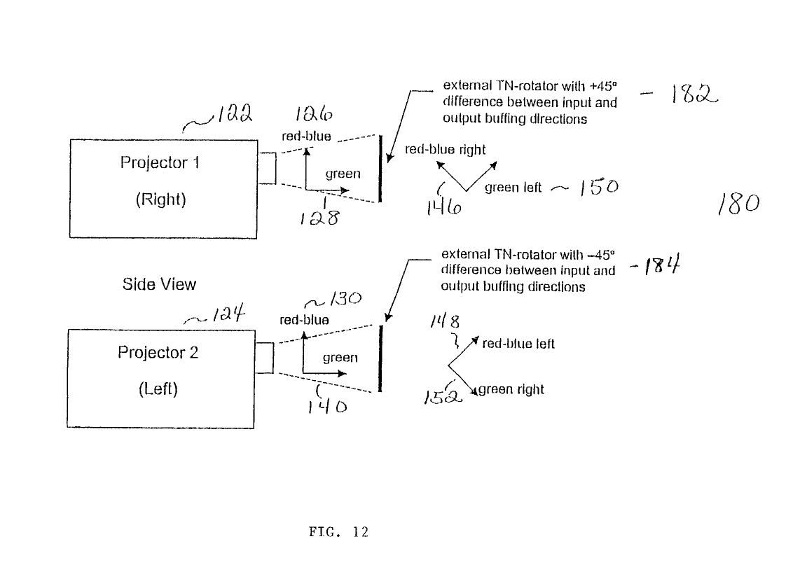

FIG. 11 illustrates a signal input diagram 160 depicting green light channel interchanging used for stereoscopic image encoding in the dual projector 3D stereoscopic systems of FIGS. 10 and 12. Two component video or VGA computer sources 162 and 164 are shown, the first source 162 for the left perspective image and the second source 164 for the right perspective image. Two p-Si projectors 166 and 168 are also depicted. To encode the 3D stereoscopic image being displayed, the green channel of the left perspective image source 170 is interchanged with the green channel of the right perspective image source 172. As is known in the art, both the left and right perspective image sources 162 and 164 should be synchronized for proper operation.

However, as previously discussed, undesirable image ghosting is likely in systems using a ½-wave retarder. Thus, the embodiment of FIG. 12 illustrates a dual projector 3D stereoscopic system 180 using dual polysilicon projectors 122 and 124 and two external TN rotators 182 and 184. The system 180 of FIG. 12 is configured similarly to the system 120 of FIG. 10, except that a TN rotator is used in FIG. 12 instead of the 2-wave retarder used in FIG. 10. In this embodiment, a 0° to 45° TN rotator 182 is applied external to the first projector 122, and a 0° to −45° TN rotator 184 is applied external to the second projector 124. As discussed, the input configuration of FIG. 11 may be used for this system 180.

The embodiment of FIG. 13 illustrates another dual projector 3D stereoscopic system 190 using dual p-Si projectors 122 and 124 and two external TN rotators 196 and 198. In this embodiment, the polarization angle 192 out of the projectors 122 and 124 is vertical for all colors. Thus, a 0° to 45° TN rotator 196 is applied external to the first projector 122, and a 0° to −45° TN rotator 198 is applied external to the second projector 124. However, the input configuration of FIG. 11 is not used in this embodiment since each color channel has the same polarization axis orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for displaying three-dimensional imagery, the system comprising:
an image source;
a first projector connected to said image source;
said first projector having a first light emission;
a second projector connected to said image source;
said second projector having a second light emission; and
a first twisted nematic liquid crystal rotator disposed in said first light emission.

2. The system of claim 1 wherein said first twisted nematic liquid crystal rotator is a 0° to 90° twisted nematic liquid crystal rotator.

3. The system of claim 2 wherein:
said first projector is an amorphous silicon thin film transistor liquid crystal display projector; and
said second projector is an amorphous silicon thin film transistor liquid crystal display projector.

4. The system of claim 3 further including:
a first touch up polarizer disposed in said first light emission at a position prior to said first light emission passing through said first twisted nematic liquid crystal rotator; and
a second touch up polarizer disposed in said second light emission.

5. The system of claim 3 wherein said first twisted nematic liquid crystal rotator is disposed in said first light emission externally to said first projector.

6. The system of claim 5 further including:
a first touch up polarizer disposed in said first light emission between said first projector and said first twisted nematic liquid crystal rotator; and
a second touch up polarizer disposed in said second light emission externally to said second projector.

7. The system of claim 1 wherein:
said first projector is a polysilicon thin film transistor liquid crystal display projector that linearly polarizes light emitted from a first red light source, a first green light source and a first blue light source; and
said second projector is a polysilicon thin film transistor liquid crystal display projector that linearly polarizes light emitted from a second red light source, a second green light source and a second blue light source.

8. The system of claim 7 further including a second twisted nematic liquid crystal rotator disposed in said second light emission.

9. The system of claim 8 wherein:
said first twisted nematic liquid crystal rotator is a 0° to 45° twisted nematic liquid crystal rotator; and
said second twisted nematic liquid crystal rotator is a 0° to −45° twisted nematic liquid crystal rotator.

10. The system of claim 9 wherein:
said first twisted nematic liquid crystal rotator is disposed in said first light emission externally to said first projector; and
said second twisted nematic liquid crystal rotator is disposed in said second light emission externally to said second projector.

11. The system of claim 1 further including a second twisted nematic liquid crystal rotator disposed in said second light emission.

12. The system of claim 11 wherein:
said first twisted nematic liquid crystal rotator is a 0° to 45° twisted nematic liquid crystal rotator; and
said second twisted nematic liquid crystal rotator is a 0° to −45° twisted nematic liquid crystal rotator.

13. The system of claim 1 wherein:
said first projector linearly polarizes light emitted from a first color channel and a second color channel and orthogonally polarizes light emitted from a third color channel with respect to said light emitted from said first color channel and said second color channel;
said second projector linearly polarizes light emitted from a first color channel and a second color channel and orthogonally polarizes light emitted from a third color channel with respect to said light emitted from said first color channel and said second color channel; and
the third channel of a first image source is interchanged with the third channel of a second image source.

14. The system of claim 13 further including a second twisted nematic liquid crystal rotator disposed in said second light emission.

15. The system of claim 14 wherein:
said first twisted nematic liquid crystal rotator is a 0° to 45° twisted nematic liquid crystal rotator; and
said second twisted nematic liquid crystal rotator is a 0° to −45° twisted nematic liquid crystal rotator.

16. The system of claim 15 wherein:
said first twisted nematic liquid crystal rotator is disposed in said first light emission externally to said first projector; and
said second twisted nematic liquid crystal rotator is disposed in said second light emission externally to said second projector.

17. The system of claim 1 wherein:
said first projector is a polysilicon thin film transistor liquid crystal display projector that linearly polarizes light emitted from a first red light source and a first blue light source and orthogonally polarizes light emitted from a first green light source with respect to said light emitted from said first red light source and said first blue light source; and
said second projector is a polysilicon thin film transistor liquid crystal display projector that linearly polarizes light emitted from a second red light source and a second blue light source and orthogonally polarizes light emitted from a second green light source with respect to said light emitted from said second red light source and said second blue light source; and
the green channel of a first image source is interchanged with the green channel of a second image source.

18. The system of claim 17 further including a second twisted nematic liquid crystal rotator disposed in said second light emission.

19. The system of claim 18 wherein:
said first twisted nematic liquid crystal rotator is a 0° to 45° twisted nematic liquid crystal rotator; and
said second twisted nematic liquid crystal rotator is a 0° to −45° twisted nematic liquid crystal rotator.

20. The system of claim 19 wherein:
said first twisted nematic liquid crystal rotator is disposed in said first light emission externally to said first projector; and
said second twisted nematic liquid crystal rotator is disposed in said second light emission externally to said second projector.

21. A system for displaying three-dimensional imagery, the system comprising:
an image source;
a first polysilicon thin film transistor liquid crystal display projector connected to said image source wherein said first projector linearly polarizes light emitted from a first red light source and a first blue light source and orthogonally polarizes light emitted from a first green light source with respect to said light emitted from said first red light source and said first blue light source;
said first projector having a first light emission;
a second polysilicon thin film transistor liquid crystal display projector connected to said image source wherein said second projector polarizes light emitted from a second red light source and a second blue light source and orthogonally polarizes light emitted from a second green light source with respect to said light emitted from said second red light source and said second blue light source;
said second projector having a second light emission;
the green channel of a first image source is interchanged with the green channel of a second image source;
a first ½ wave retarder disposed in said first light emission; and
a second ½ wave retarder disposed in said second light emission.

22. The system of claim 21 wherein:
said first ½ wave retarder is oriented −22.5° with respect to the orientation angle of said first red light source and said first blue light source; and
said second ½ wave retarder is oriented +22.5° with respect to the orientation angle of said second red light source and said second blue light source.

23. The system of claim 21 wherein:
said first ½ wave retarder is disposed in said first light emission externally to said first projector; and
said second ½ wave retarder is disposed in said second light emission externally to said second projector.

24. A method for displaying three-dimensional imagery using a projection system having a first projector and a second projector using a first twisted nematic liquid crystal rotator, the method comprising:
determining a polarization angle of light emitted from said first projector;
determining a polarization angle of light emitted from said second projector;
altering said polarization angle of light emitted from said first projector to be orthogonal to said polarization angle of light emitted from said second projector; and
wherein said altering said polarization angle of light emitted from said first projector comprises using said first twisted nematic liquid crystal rotator.

25. The method of claim 24 wherein said first twisted nematic liquid crystal rotator is a 0° to 90° twisted nematic liquid crystal rotator.

26. The method of claim 25 wherein:
said first projector is an amorphous silicon thin film transistor liquid crystal display projector; and
said second projector is an amorphous silicon thin film transistor liquid crystal display projector.

27. The method of claim 26 further including:
applying a first touch up polarizer to said first projector; and
applying a second touch up polarizer to said second projector.

28. The method of claim 26 wherein said first twisted nematic liquid crystal rotator is applied externally to said first projector.

29. The method of claim 28 wherein:
said applying said first touch up polarizer to said first projector includes applying said first touch up polarizer externally to said first projector; and
said applying said second touch up polarizer to said second projector includes applying said second touch up polarizer externally to said second projector.

30. The method of claim 24 wherein:
said first projector is a polysilicon thin film transistor liquid crystal display projector that linearly polarizes light emitted from a first red light source, a first green light source and a first blue light source; and
said second projector is a polysilicon thin film transistor liquid crystal display projector that linearly polarizes light emitted from a second red light source, a second green light source and a second blue light source.

31. The method of claim 30 further including:
altering said polarization angle of light emitted from said second projector to be orthogonal to said polarization angle of light emitted from said first projector; and
wherein said altering said polarization angle of light emitted from said second projector comprises using a second twisted nematic liquid crystal rotator.

32. The method of claim 31 wherein:
said first twisted nematic liquid crystal rotator is a 0° to 45° twisted nematic liquid crystal rotator; and
said second twisted nematic liquid crystal rotator is a 0° to −45° twisted nematic liquid crystal rotator.

33. The method of claim 32 wherein:
said first twisted nematic liquid crystal rotator is applied externally to said first projector; and
said second twisted nematic liquid crystal rotator is applied externally to said second projector.

34. The method of claim 24 further including:
altering said polarization angle of light emitted from said second projector to be orthogonal to said polarization angle of light emitted from said first projector; and
wherein said altering said polarization angle of light emitted from said second projector comprises using a second twisted nematic liquid crystal rotator.

35. The method of claim 34 wherein:
said first twisted nematic liquid crystal rotator is a 0° to 45° twisted nematic liquid crystal rotator; and
said second twisted nematic liquid crystal rotator is a 0° to −45° twisted nematic liquid crystal rotator.

36. The method of claim 24 wherein:
said first projector linearly polarizes light emitted from a first color channel and a second color channel and orthogonally polarizes light emitted from a third color channel with respect to said light emitted from said first color channel and said second color channel;
said second projector linearly polarizes light emitted from a first color channel and a second color channel and orthogonally polarizes light emitted from a third color channel with respect to said light emitted from said first color channel and said second color channel; and
the third channel of a first image source is interchanged with the third channel of a second image source.

37. The method of claim 36 a further including altering said polarization angle of light emitted from said second projector to be orthogonal to said polarization angle of light emitted from said first projector; and
wherein said altering said polarization angle of light emitted from said second projector comprises using a second twisted nematic liquid crystal rotator.

38. The method of claim 37 wherein:
said first twisted nematic liquid crystal rotator is a 0° to 45° twisted nematic liquid crystal rotator;
said second twisted nematic liquid crystal rotator is a 0°-45° twisted nematic liquid crystal rotator.

39. The method of claim 38 wherein:
said first twisted nematic liquid crystal rotator is applied externally to said first projector; and
said second twisted nematic liquid crystal rotator is applied externally to said second projector.

40. The method of claim 24 wherein:
said first projector is a polysilicon thin film transistor liquid crystal display projector that linearly polarizes light emitted from a first red light source and a first blue light source and orthogonally polarizes light emitted from a first green light source with respect to said light emitted from said first red light source and said first blue light source;
said second projector is a polysilicon thin film transistor liquid crystal display projector that linearly polarizes light emitted from a second red light source and a second blue light source and orthogonally polarizes light emitted from a second green light source with respect to said light emitted from said second red light source and said second blue light source; and
the green channel of a first image source is interchanged with the green channel of a second image source.

41. The method of claim 40 further including altering said polarization angle of light emitted from said second projector to be orthogonal to said polarization angle of light emitted from said first projector; and
wherein said altering said polarization angle of light emitted from said second projector comprises using a second twisted nematic liquid crystal rotator.

42. The method of claim 41 wherein:
said first twisted nematic liquid crystal rotator is a 0° to 45° twisted nematic liquid crystal rotator;
said second twisted nematic liquid crystal rotator is a 0° to −45° twisted nematic liquid crystal rotator.

43. The method of claim 42 wherein:
said first twisted nematic liquid crystal rotator is applied externally to said first projector; and
said second twisted nematic liquid crystal rotator is applied externally to said second projector.

44. A method for displaying three-dimensional imagery using a projection system having a first projector and a second projector and using a first ½ wave retarder and a second ½ wave retarder, the method comprising:
determining a polarization angle of light emitted from said first projector wherein said first projector is a polysilicon thin film transistor liquid crystal display projector that linearly polarizes light emitted from a first red light source and a first blue light source and orthogonally polarizes light emitted from a first green light source with respect to said light emitted from said first red light source and said first blue light source;
determining a polarization angle of light emitted from said second projector wherein said second projector is a polysilicon thin film transistor liquid crystal display projector that linearly polarizes light emitted from a second red light source and a second blue light source and orthogonally polarizes light emitted from a second green light source with respect to said light emitted from said second red light source and said second blue light source;
interchanging the green channel of a first image source with the green channel of a second image source;
altering said polarization angle of light emitted from said first projector to be orthogonal to said polarization angle of light emitted from said second projector;
wherein said altering said polarization angle of light emitted from said first projector comprises using said first ½ wave retarder;
altering said polarization angle of light emitted from said second projector to be orthogonal to said polarization angle of light emitted from said first projector; and
wherein said altering said polarization angle of light emitted from said first projector comprises using said second ½ wave retarder.

45. The method of claim 44 wherein:
said first ½ wave retarder is applied in an orientation of −22.5° with respect to the orientation angle of said first red light source and said first blue light source; and
said second ½ wave retarder is applied in an orientation of +22.5° with respect to the orientation angle of said second red light source and said second blue light source.

46. The method of claim 44 wherein:
said first ½ wave retarder is applied externally to said first projector; and
said second ½ wave retarder is applied externally to said second projector.
